(19) United States
(12) Patent Application Publication
(10) Pub. No.: US 2008/0100596 A1
(43) Pub. Date: May 1, 2008

(54) Digital Photo Frame with Monthly Calendar

(76) Inventor: Juen-Tien Peng, Chung Li (TW)

Correspondence Address: HDSL, 4331 STEVENS BATTLE LANE, FAIRFAX, VA, 22033, US

(21) Appl. No.: 11/554,760

(22) Filed: Oct. 31, 2006

(51) Int. Cl. G09G 5/00

(52) U.S. Cl. 345/204

(57) ABSTRACT

A digital photo frame with a monthly calendar includes: at least one storage device for storing a digital photo or image, a processing unit for processing the digital photo stored in the storage device; a time unit for providing a function of calculating a current date and time, the current date and time may be transformed into an electric signal and transported into the processing unit; a display device for displaying the digital photo/image, current date and time processed by the processing unit. With this configuration, the digital photo frame with a monthly calendar according to the invention is functional equivalent to an aggregate of a traditional digital photo frame, a clock and a calendar, which may save rare space of the surface of a desk.

### BACKGROUND

The invention relates to a digital photo frame, more particularly to a digital photo frame with a monthly calendar and a clock, which can display current date and time.

With the increasing development of the technologies, a digital camera has been becoming a substitute of a traditional camera progressively because of many advantages of the digital camera. For example, when the traditional camera works, a negative or film is needed, and the negative or film can only be used once without recycle. In contrast to the traditional camera, using the digital camera, you can get some electronic files, and the files can be stored and managed in a computer.

Since the digital camera is used world widely, people are watching a photo in a different manner than the past. Thus a digital photo frame is invented to meet the demand, with the digital photo frame, you can enjoy a photo without being developed.

Substantially, a digital photo frame is an apparatus displaying information, such as a digital photo or image, in a liquid crystal display panel, and often is arranged on a desk. Additionally, it is important information for everybody to know the current date and time frequently, so a calendar and a clock often are arranged on a desk, too. Thus the digital photo frame, the calendar and the clock may occupy much space of the desk. Additionally, the digital frame has a display screen and the display screen may be used to display date and time, at the same time, the digital photo may be used as a background, which is convenient for a user. Furthermore, the background may be changed constantly, and a user may select a photo as he/she likes to arrange the desktop.

Thus, a new device which overcomes the above-mentioned disadvantages is desired.

### BRIEF SUMMARY

The invention is to provide a digital frame with a monthly calendar. According to one aspect of the invention, a time unit is disposed in a traditional digital frame, when a power supply is provided to the digital frame, the time unit may calculate to get a real time, and a processing unit may display the current time/date in a display device, thus the digital frame with monthly calendar works as a traditional digital frame, a clock and a calendar.

The invention is to provide a digital frame with a monthly calendar. According to one aspect of the invention, a real time chip (RTC) is used a time unit to gain the real time/date.

The invention is to provide a digital frame with a monthly calendar. According to one aspect of the invention, the digital image and the date/time may be displayed in the digital photo frame together or separately. When the digital image and the date/time may be displayed in the digital photo frame together, the digital image and the date/time may overlap each other, such as the date/time overlap above the digital photo, or the other arrangements.

According to an aspect of the invention, a digital photo frame with a monthly calendar includes: at least one storage device for storing a digital photo or image, a processing unit for processing the digital photo stored in the storage device; a time unit for providing a function of calculating a current date and time, the current date and time may be transformed into an electric signal and transported into the processing unit; a display device for displaying the digital photo/image, current date and time processed by the processing unit.

According to an aspect of the invention, a digital photo frame includes: a processing unit for processing a digital photo or image, a time unit for providing a current time; and a display device for displaying the current time, digital photo or image processed by the processing unit.

With this configuration, the digital photo frame according to the invention is functional equivalent to an aggregate of a traditional digital photo frame, a clock and a calendar, which may save rare space of the surface of a desk.

Advantageously, a user can switch the current display mode into another display mode by operating a button, that is, the digital photo frame according to the invention is useful, convenient and easy to operate on.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 illustrates a diagram of a digital photo frame with a monthly calendar according to one embodiment of the present invention.

FIG. 2 illustrates a display mode of the date/time and the digital photo in a display device, according to one embodiment of the present invention.

FIG. 3 illustrates another display mode of the date/time and the digital photo in a display device, according to one embodiment of the present invention.

### DETAILED DESCRIPTION

The invention provides a digital photo frame with a monthly calendar, in which, a digital photo frame, a monthly calendar and a clock are combined as a whole. Concretely, according to one embodiment of the invention, an electric clock ASIC (Application Specific Integrated Circuit, ASIC) is built in a digital photo frame, thus the digital photo frame can display the current date and time, at the same time, the digital photo frame only occupy less space.

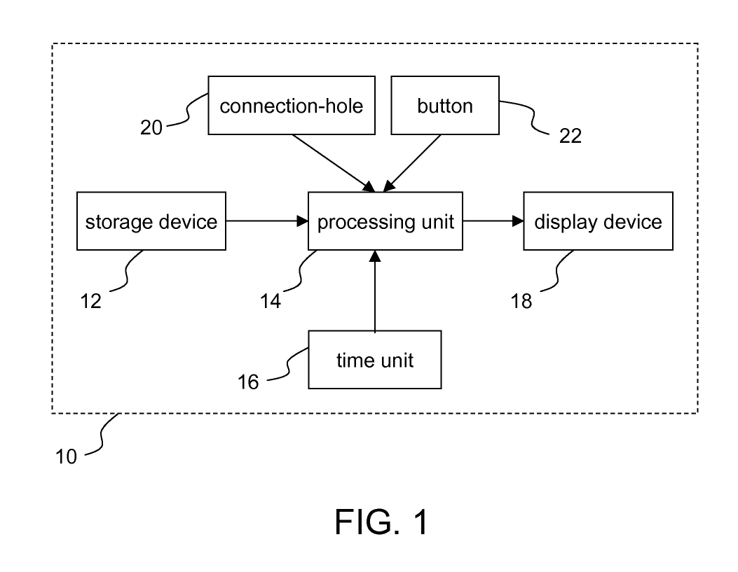

As shown in FIG. 1, a digital photo frame 10 with a monthly calendar according to one embodiment of the invention includes a storage device 12, a processing unit 14, a time unit 16 and a display device 18. The storage device 12 is used for storing digital photos or images. The processing unit 14 can decode digital images and control a liquid crystal display panel, so the processing unit 14 is used for processing the digital images stored in the storage device 12 and making the images displayed in the display device 18. The time unit 16 is a real time clock IC (Real time clock IC, RTC). As an ASIC, when given a power supply, an electronic clock in the time unit 16 works continuously, and the time unit 16 transforms the real time into an electronic signal and outputs the electronic signal, thus the real date and time can be gained. The real date and time can be displayed in the display device 18, wherein the time may be displayed via a clock hand or a number. The display device 18 is a display apparatus, for example, a liquid crystal display device (LCD), or a plasma display panel (PDP), etc. According to the invention, the digital photo frame 10 may include at least one connection-hole 20 for interconnecting with a digital camera or a memory card and reading digital information from them.

In addition, according the invention, the digital photo frame 10 may include at least one button 22. With the button 22, a user can adjust the current date and time, and switch the display modes of the current date and time. The display modes include single display mode and multi-display mode. When the digital photo frame 10 works in the single display mode, either the date (time) or the digital images are displayed, the digital photo frame 10 works just as a clock or a traditional digital photo frame. When the digital photo frame 10 works in the multi-display mode, both the date (time) and the digital images are displayed at the same time.

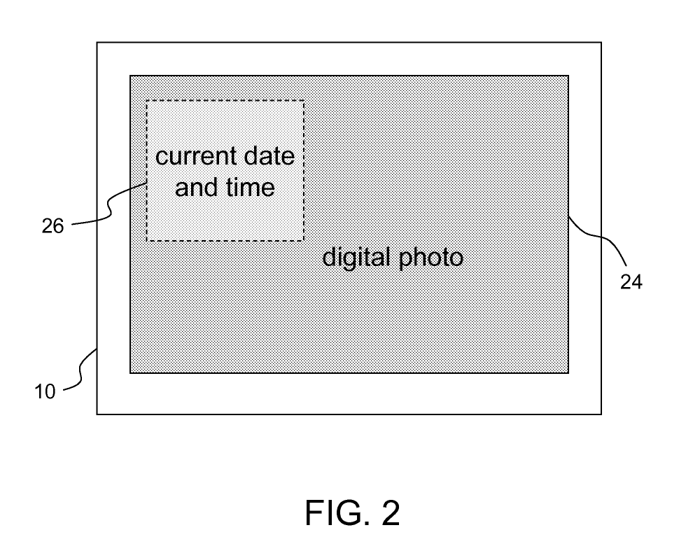

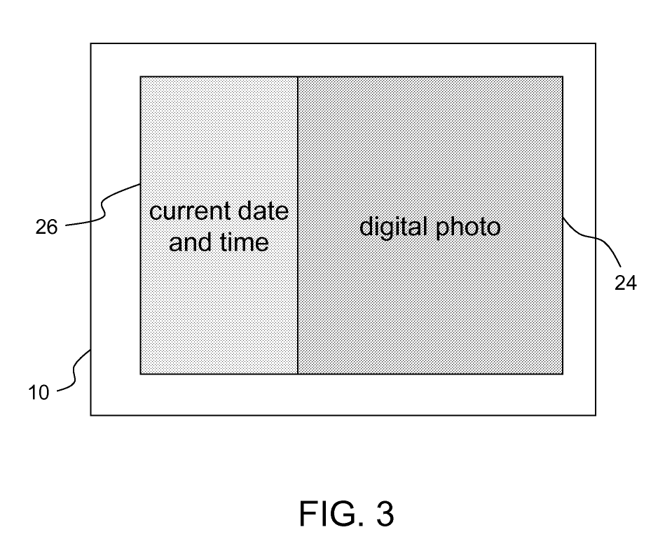

When the digital photo frame 10 works in the multi-display mode, the date (time) and the digital images may be arranged in many forms. One form is shown in FIG. 2, the digital image 24 and the date (time) 26 overlap each other, and both are displayed in the digital photo frame 10; as a substitution, the date (time) 26 may overlap on a part of the digital image 24, for example, the part may be the center, the upper right or all of the digital image 24. Another form is shown in FIG. 3, the digital image 24 and the date (time) 26 may be displayed in the digital photo frame 10 together, that is, the digital image 24 is displayed alongside of the date (time) 26. The digital image 24 may be displayed above the date (time) 26; alternatively, the digital image 24 may be displayed on the left or right of the date (time) 26.

Additionally, the user may push the button 22 to switch the display contents, the display contents may include: the date of the current week, the date of the current month, the current date of the day, the user can select one of the contents to display in the digital photo frame 10. Every one (group) display content is set as one display mode in the operating interface, the user can push the button 22 or remote-controlled to change the display modes without complicated operating steps.

Advantageously, The above description is given by way of example, and not limitation, and some change or modification may be provided. The display mode of the current date and time may be switched through a remote device. The digital photo frame according to the invention may include an external image module for providing a photo or image to the processing unit, the external image module may be an image capturing device or a hard disk, or a memory card, or a image server accessible over a network connection, etc. The image capturing device may be a digital still camera, or a camcorder via a camcorder module to connect to said digital photo frame.

In summary, the invention provides a digital photo frame with a monthly calendar. An RTC is built in the digital photo frame. Electrically connecting a power supply, an electronic clock in the time unit can work by itself, and a real date and time can be gained. The real date and time can be displayed in a display device. So the digital photo frame according to the invention is functional equivalent to an aggregate of a traditional digital photo frame, a clock and a calendar, which may save rare space of the surface of a desk. Additionally, a user can switch one display mode into another display mode by operating a button, that is, the digital photo frame according to the invention is useful, convenient and easy to operate on.

The above description is given by way of example, and not limitation. Given the above disclosure, one skilled in the art could devise variations that are within the scope and spirit of the invention disclosed herein, including configurations ways of the recessed portions and materials and/or designs of the attaching structures. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A digital photo frame with a monthly calendar comprising:
at least one storage device for storing a digital photo or image;
a processing unit for processing the digital photo or image stored in the storage device;
a time unit for providing a function of calculating a current date and time, the current date and time may be transformed into an electric signal and transported into the processing unit; and
a display device for displaying the digital photo/image, current date and time processed by the processing unit.

2. The digital photo frame according to claim 1, wherein the display device is a liquid crystal display device.

3. The digital photo frame according to claim 1, wherein the current date and time is adjustable manually.

4. The digital photo frame according to claim 1, wherein the digital photo, the current date and time may be displayed together in the display device.

5. The digital photo frame according to claim 1, further comprising at least one connection-hole for interconnecting a digital camera or a memory card.

6. The digital photo frame according to claim 1, wherein the current date and time is displayed alone in the display device.

7. The digital photo frame according to claim 1, wherein the relative position of the digital photo/image and the current date/time is adjustable manually, or the digital photo/image and the current date/time overlap each other.

8. The digital photo frame according to claim 1, wherein the time is displayed via a clock hand or a number.

9. The digital photo frame according to claim 1, wherein the date displayed in the display device comprises: the date of the current week, the date of the current month, and/or the current date of the day.

10. The digital photo frame according to claim 1, wherein the time unit is a Real time clock IC.

11. The digital photo frame according to claim 1, further comprising at least one button for switching a display mode of the current date and time.

12. The digital photo frame according to claim 11, wherein a display mode of the current date and time may be switched through a remote device.

13. The digital photo frame according to claim 1, wherein a display mode of the current date and time may be switched through a remote device.

14. A digital photo frame comprising:
a processing unit for processing a digital photo or image
a time unit for providing a current time; and
a display device for displaying the current time, digital photo or image processed by the processing unit.

15. The digital photo frame according to claim 14, further comprising an external image module for providing a photo or image to the processing unit.

16. The digital photo frame according to claim 15, wherein the external image module is an image capturing device.

17. The digital photo frame according to claim 16, wherein the image capturing device is a digital still camera, or a camcorder via a camcorder module to connect to said digital photo frame.

18. The digital photo frame according to claim 15, wherein the external image module is a hard disk, or a memory card, or a image server accessible over a network connection.

19. The digital photo frame according to claim 15, wherein the display device is a liquid crystal display device or a plasma display panel.

20. The digital photo frame according to claim 14, further comprising at least one button for switching a display mode of the current time.
